(19) United States
(12) Patent Application Publication
(10) Pub. No.: US 2010/0019067 A1
(43) Pub. Date: Jan. 28, 2010

(54) SHOWER HEAD

(76) Inventor: Yoji Okuma, Fukuoka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 12/439,615

(22) PCT Filed: Aug. 29, 2007
(86) PCT No.: PCT/JP2007/066787

§ 371 Date: Mar. 2, 2009

(30) Foreign Application Priority Data
Sep. 5, 2006 (JP) 2006-240554

(51) Int. Cl. B05B 7/08

(52) U.S. Cl. 239/549

(57) ABSTRACT

A shower head (10) including: a shower head body (13) having a water inlet (11) formed at a proximal end of the body (13), and a sprinkler portion (18) disposed at a distal end of the body (13) and having a plurality of sprinkler holes (16),

wherein the body (13) includes: a tubular handle portion (27) having a water passage (12) inside, the water passage (12) having the water inlet (11) at a proximal end thereof; and a discharge head portion (28) integrally joined to a distal end of the handle portion (27), and
wherein a space (20) enclosed by the discharge head portion (28) and the sprinkler portion (18) is provided with a cavitating mechanism (57) for partially causing a cavitation phenomenon due to a change in cross section of water flow therein.

### TECHNICAL FIELD

The present invention relates to a shower head which is operable to kill, during use, bacteria present in residual water in the shower head.

### BACKGROUND ART

Examples of conventional water-saving type shower heads include shower heads each having a diameter-reduced water passage upstream from a sprinkler plate used for water drainage. Japanese Patent Gazette No. 2670509, for example, describes a shower head in which the diameter-reduced water passage has at its entry side a tapered diameter-reduced portion reduced in diameter in the flow direction and at its exit side a diameter-increased portion increased in diameter in the flow direction. The diameter-reduced water passage enhances the velocity of water flowing therethrough, and, due to the increase in diameter at the exit side, allows the water flow to impinge upon the sprinkler plate without decreasing the kinetic energy of the velocity-enhanced water flow. The diameter-reduced water passage with this structure prevents a lowering in water pressure in the shower head caused by turning down a faucet connected to the shower head for saving water.

In the invention of the Gazette, however, the enlarged diameter at the exit side of the diameter-reduced water passage causes an increased amount of water to remain in the shower head when the use of the shower is stopped. Such structure creates inside the shower head an environment conducive to the growth of bacteria when the shower is out of use. A resulting problem is that, when the use of the shower is started, part of the proliferated bacteria are mixed with shower water and released from the shower head to be spread out. Another problem is that the rest of the bacteria remain on inner faces of a shower hose and of the shower head, so that the shower head is left contaminated with the bacteria all the time.

The present invention has been made in view of the above problems, and it is an object of the present invention to provide a shower head which is operable to kill bacteria present in residual water within the shower head.

### DISCLOSURE OF INVENTION

To accomplish the above object, a first invention provides a shower head comprising a cavitating mechanism in a water passage for partially generating a cavitation phenomenon due to a change in cross section of water flow therein.

In the shower head according to the first invention, the cavitating mechanism may comprise: a reduced water-passage for accelerating introduced water and increasing the pressure of the water; and an enlarged water-passage for rapidly decelerating the water which has passed through the reduced water-passage and decreasing the pressure of the water.

According to a second invention, there is provided a shower head including: a shower head body having a water inlet formed at a proximal end of the body, and a sprinkler portion disposed at a distal end of the body and having a plurality of sprinkler holes,

wherein the body comprises: a tubular handle portion having a water passage inside, the water passage having the water inlet at a proximal end thereof; and a discharge head portion integrally joined to a distal end of the handle portion, and
wherein a space enclosed by the discharge head portion and the sprinkler portion is provided with a cavitating mechanism for partially generating a cavitation phenomenon due to a change in cross section of water flow therein.

Thus, the shower head can be compact, and further can be easily combined with a water-saving mechanism.

In the shower head according to the second invention, the cavitating mechanism may be formed by a reduced water-passage and an enlarged water-passage, the reduced water-passage eccentrically formed in a partition plate, the partition plate provided at a distal end of the discharge head portion, the enlarged water-passage located downstream from the reduced water-passage and upstream from the sprinkler portion.

Further, in the shower head according to the second invention, the cavitating mechanism may be formed by a water passage portion, the water passage portion having a reduced water-passage located upstream and an enlarged water-passage located downstream.

According to a third invention, there is provided a shower head including: a shower head body having a water inlet formed at a proximal end of the body, and a sprinkler portion disposed at a distal end of the body and having a plurality of sprinkler holes,

wherein the body comprises: a tubular handle portion having a water passage inside, the water passage having the water inlet at a proximal end thereof; and a discharge head portion integrally joined to a distal end of the handle portion, and
wherein the handle portion is provided with a cavitating mechanism for partially generating a cavitation phenomenon due to a change in cross section of water flow therein.

The shower head according to the third invention may have one or more such cavitating mechanisms.

In the shower heads according to the first to third inventions, there occurs a cavitation phenomenon (cavitation) wherein a great number of fine vapor bubbles are formed in a reduced pressure zone inside the water flow. In this instance, bacteria are exposed to the reduced pressure zone and killed. Further, shock waves are produced when the vapor bubbles vanish and the shock waves impinge upon bacteria, and the impact forces produced at that time result in the physical breakup (killing) of the bacteria. As a result, the bacteria harmful to human bodies are removed to provide a sanitary shower water. Experiments proved remarkable sterilization of water collected especially in the shower head and a hose connected thereto.

### BRIEF DESCRIPTION OF DRAWINGS

FIG. 1 is a sectional side elevation of a shower head according to a first embodiment of the present invention.

FIG. 2 is an exploded perspective view of a sprinkler portion of the shower head.

FIG. 3 is an explanatory view of a reduced water-passage formed in the shower head.

FIG. 4 is a sectional side elevation of a shower head according to a second embodiment of the present invention.

FIG. 5(A) is a sectional side elevation of a shower head according to a third embodiment of the present invention, FIG. 5(B) is a cross sectional view taken on line P-P, and FIG. 5 (C) is a cross sectional view taken on line Q-Q.

### BEST MODE FOR CARRYING OUT THE INVENTION

Referring to the accompanying drawings, embodiments of the present invention will now be described for a better understanding of the present invention.

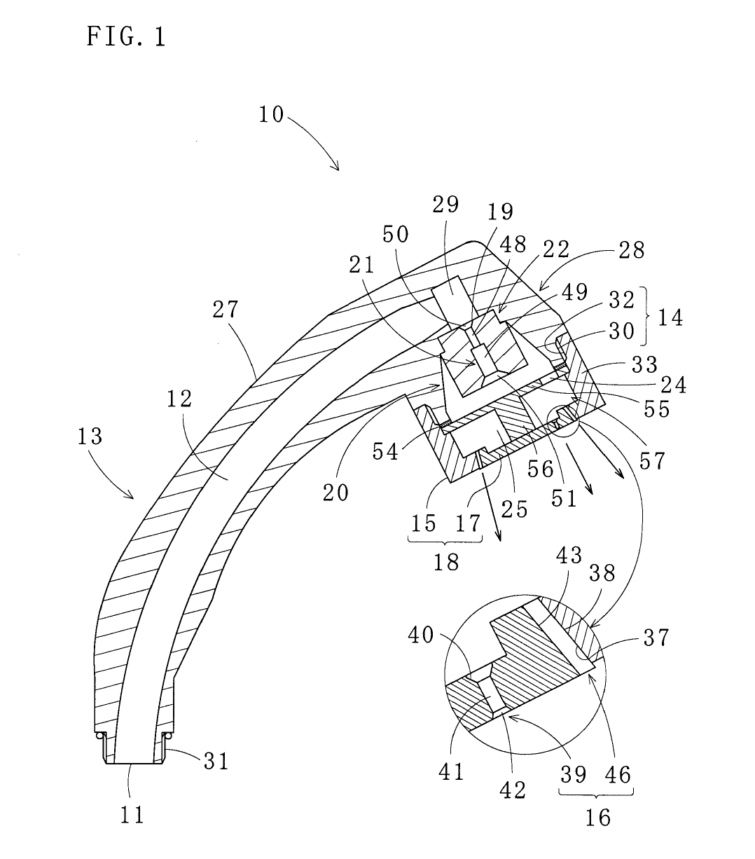

As illustrated in FIG. 1, a shower head 10 according to a first embodiment of the present invention includes a shower head body (shower nozzle) 13 and a sprinkler portion 18. The shower head body 13 has a water passage 12 inside and a water inlet 11 at the proximal end of the water passage 12. The sprinkler portion 18 has a ring-shaped cap 15 fixed to the distal end of the shower head body 13 via a screw mechanism 14, and a sprinkler plate 17 fitted in the cap 15. The sprinkler plate 17 is formed with a plurality of sprinkler holes 16.

The shower head body 13 is made of, for example, an ABS resin, which is an example of hard resins, and includes a tubular handle portion 27 and a discharge head portion 28 integrally joined to the distal end of the handle portion 27. The handle portion 27 has the water passage 12 inside and the water inlet 11 at the proximal end of the water passage 12. Formed between a water outlet 19 of the water passage 12 and the sprinkler plate 17 is a space 20 enlarged in the flow direction. Disposed in the space 20 is a water passage portion 22 formed with a water channel 21. The proximal end of the water passage portion 22 is in close contact with the water outlet 19.

Disposed between the water passage portion 22 and the sprinkler plate 17 is a partition plate 55. The partition plate 55, located upstream from the sprinkler plate 17, has a reduced water-passage 24 eccentrically formed therein. The reduced water-passage 24 is spaced apart from the distal end of the water passage portion 22, and is defined by a through-hole designed to reduce the cross sectional area of water flow. Due to this structure, an enlarged water-passage 25 is formed in the space 20 and downstream from the reduced water-passage 24. The enlarged water-passage 25 has a cross-sectional area ten times or more larger than that of the reduced water-passage 24. The shower head 10 is formed with a water flow channel, which comprises: the water passage 12; an inflected water passage 29 to be described later; and the space 20. Now, these components will be described in detail.

Provided at a distal end of the water passage 12 is the inflected water passage 29. The inflected water passage 29 is coupled to the water passage 12 at a substantially right-angled bend and has the water outlet 19 in the center of the distal end of the inflected water passage 29. The discharge head portion 28 of the shower head body 13 has, on the outer side at its distal end, a male screw portion 30 to which the cap 15 is attached. The shower head body 13 has, on the outer side at its proximal end, a male screw portion 31 to be fitted into a joint located at the distal end of a shower hose (not illustrated).

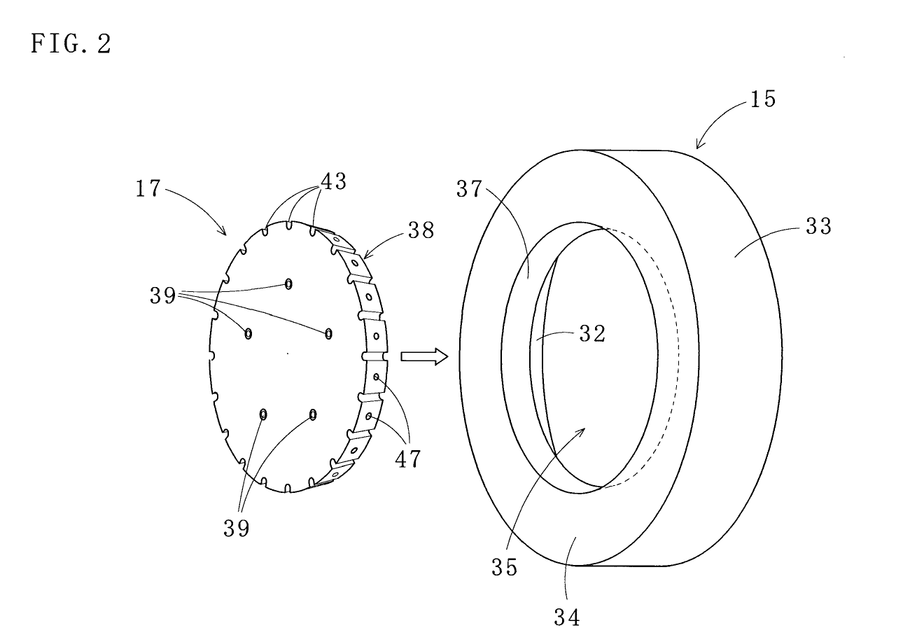

As illustrated in FIGS. 1 and 2, the cap 15, a component of the sprinkler portion 18, includes a side wall portion 33 and an annular-shaped plate portion 34. The side wall portion 33 has on an inner side a female screw portion 32 to be fitted on the male screw portion 30 of the shower head body 13. Formed in the center of the plate portion 34 is an inversely tapered fitting opening 35 with a diameter gradually increasing in the flow direction. The male screw portion 30 of the shower head body 13 and the female screw portion 32 of the cap 15 form the screw mechanism 14. The sprinkler plate 17 is made of a circular disk having an inversely tapered outer wall 38. The sprinkler plate 17 is substantially identical in configuration to the fitting opening 35 defined by an inner wall 37 of the cap 15 and has a diameter gradually increasing in the flow direction. The sprinkler plate 17 is fixedly inserted into the fitting opening 35 formed in the center of the cap 15.

The sprinkler plate 17 has, in the inner area thereof but not in the periphery thereof, a plurality of (e.g., five) inner sprinkler holes 39 circular in cross section that extend parallel to the axis of the sprinkler plate 17. The inner sprinkler holes 39 each have a water entry portion 40. The water entry portion 40 is gradually reduced in diameter in the flow direction in a truncated conical (tapered) shape, so that water is efficiently introduced into the inner sprinkler hole 39 and the fluid resistance in the inner sprinkler holes 39 is reduced with a resultant decrease in pressure loss. The inner sprinkler holes 39 each have a water exit portion 42 located downstream from the water entry portion 40 with a straight portion 41 formed therebetween. The water exit portion 42 is gradually increased in diameter in the flow direction in a truncated conical (inversely tapered) shape. Due to this structure, the water accelerated by the diameter-reduced portion of the inner sprinkler hole 39 is discharged vigorously from the inner sprinkler hole 39 without a decrease in the kinetic energy of the water flow and with a gradual increase in the diameter of the water flow. Thus, a user feels no pain when the water is showered on the user's body.

The outer wall 38 defining the periphery of the sprinkler plate 17 is formed with a plurality of (e.g., 20) grooves 43. The grooves 43 are spaced apart from one another in the circumferential direction, and extend in the flow direction. The grooves 43 each are U-shaped in cross section with a mouth opening toward the outward side. By bringing the sprinkler plate 17 into the fitting opening 35 of the cap 15 from the tip of the cap 15 to fixedly secure the outer wall 38 of the sprinkler plate 17 to the inner wall 37 of the cap 15, 20 outer sprinkler holes 46 are formed by the grooves 43 of the sprinkler plate 17 and the inner wall 37 of the cap 15. Because the grooves 43, formed in the sprinkler plate 17 and constituting the outer sprinkler holes 46, are each U-shaped in cross section with a mouth opening toward the radially outward side of the sprinkler plate 17 (e.g., the U-shaped grooves each are 0.7 to 1 mm in width), water droplets hardly remain in the outer sprinkler holes 46 to prevent adhesion of calcium, etc., present in water supplied to the shower head 10. The sprinkler holes 16 include the inner sprinkler holes 39 and the outer sprinkler holes 46.

The sprinkler plate 17 is thicker peripherally than centrally so that the outer sprinkler hole 46 has a length greater than (e.g., twice to three times) the length of the inner sprinkler hole 39. Due to this constitution, the shower water jets from the inner sprinkler holes 39 flow parallel to the axis of the sprinkler portion 18 while gradually spreading out, whereas the shower water jets from the outer sprinkler holes 46 form a curtain-like water stream in a truncated cone having a diameter gradually increasing in the flow direction about the axis of the sprinkler portion 18, the curtain-like water stream surrounding the shower water jets from the inner sprinkler holes 39.

As illustrated in FIG. 2, the outer wall 38 of the sprinkler plate 17, before being secured to the fitting opening 35 of the cap 15, has a plurality of projections 47 for welding. The projections 47 are minute in height, and are spaced apart from one another in the circumferential direction. By inserting the sprinkler plate 17 into the fitting opening 35 and then applying the ultrasonic vibration to the sprinkler plate 17 to melt the projections 47, the sprinkler plate 17 is secured to the fitting opening 35 easily and tightly. Since the projections 47 are minute in height, there is no risk of clogging up of the outer sprinkler holes 46 with the melt projections 47.

The water channel 21 formed in the water passage portion 22, part of a water-saving mechanism, includes a first water passage 48 at an entry side and a second water passage 49 at an exit side. The first water passage 48 communicates with the inflected water passage 29 of the shower head body 13 and is smaller in cross-sectional area than both the water passage 12 and the inflected water passage 29. The second water passage 49 is greater in inner diameter than the first water passage 48. The water channel 21 further includes a tapered intake portion 50 formed upstream from the first water passage 48 and a tapered discharge portion 51 formed downstream from the second water passage 49. The tapered intake portion 50 is reduced in the flow direction. The tapered discharge portion 51 is enlarged in the flow direction. Thus, water is efficiently taken into the first water passage 48 from the inflected water passage 29 with its resistance reduced, and the water taken in is discharged from the second water passage 49 without a decrease in the kinetic energy of the water.

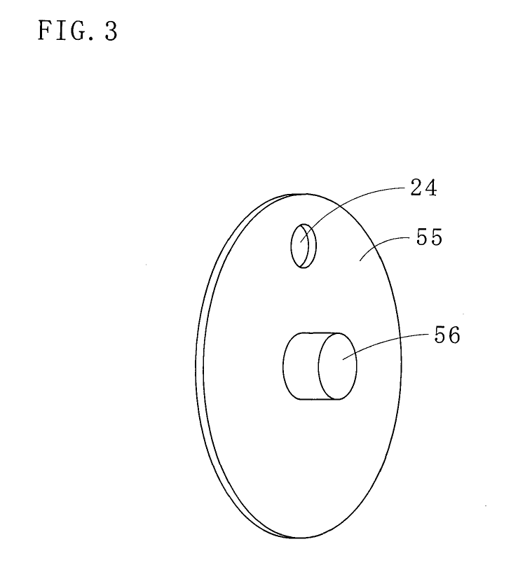

As illustrated in FIGS. 1 and 3, the reduced water-passage 24 is formed off-center as mentioned above in the partition plate 55 disposed perpendicularly to the flow direction in the space 20 of the shower head body 13. The partition plate 55 is mounted on a ring-shaped rubber packing 54 carried on the distal end of the male screw portion 30 of the discharge head portion 28, and is press-fitted on the distal end of the male screw portion 30 by the cap 15 threaded on the male screw portion 30 of the shower head body 13. Thus, the partition plate 55 is attached in close contact to the distal end of the male screw portion 30 of the discharge head portion 28, and a water seal is formed between the discharge head portion 28 and the cap 15. Formed in the center of the partition plate 55 is a cylindrical supporter 56 to be in contact with a center of the sprinkler plate 17 of the sprinkler portion 18 when the partition plate 55 is attached to the discharge head portion 28. The cylindrical supporter 56 prevents flexure of the partition plate 55 caused by water pressure during use.

Due to this constitution, the water discharged from the discharge portion 51 of the water channel 21, when flowing through the reduced water-passage 24, is accelerated and increased in pressure, and, when discharged into the enlarged water-passage 25, rapidly decelerated and reduced in pressure. Thus, the reduced water-passage 24 and the enlarged water-passage 25 constitute a cavitating mechanism 57 for partially generating a cavitation phenomenon due to a change in cross section of the water flow.

Next, the function of the shower head 10 according to the first embodiment of the present invention will be described. When a faucet or a hot and cold water mixing faucet (not illustrated) is opened, water having a certain water pressure is supplied through a shower hose (not illustrated) to the water inlet 11 of the shower head 10. Then, the water supplied through the water inlet 11 into the water passage 12 flows through the water outlet 19 of the inflected water passage 29 and through the intake portion 50 of the water channel 21 into the first water passage 48. The water in the first water passage 48 travels through the second water passage 49, and then is discharged from the discharge portion 51 onto the partition plate 55.

The water discharged onto the partition plate 55, when flowing through the reduced water-passage 24, is accelerated and increased in pressure, and then, when discharged into the enlarged water-passage 25, rapidly decelerated and quickly reduced in pressure. In the enlarged water-passage 25, as a result, cavitation (a cavitation phenomenon) occurs, and water boils or almost boils without a rise in water temperature to form vapor bubbles. At this time, bacteria in the water are exposed to a reduced pressure zone, and killed. When the pressure of the water discharged in the enlarged water-passage 25 is restored, the generated bubbles collapse with formation of shock waves, which propagate around. The shock waves impinge upon bacteria, and the impact forces produced at that time result in the physical breakup (killing) of the bacteria. The sterilized water is discharged through the inner sprinkler holes 39 and the outer sprinkler holes 46 of the sprinkler portion 18.

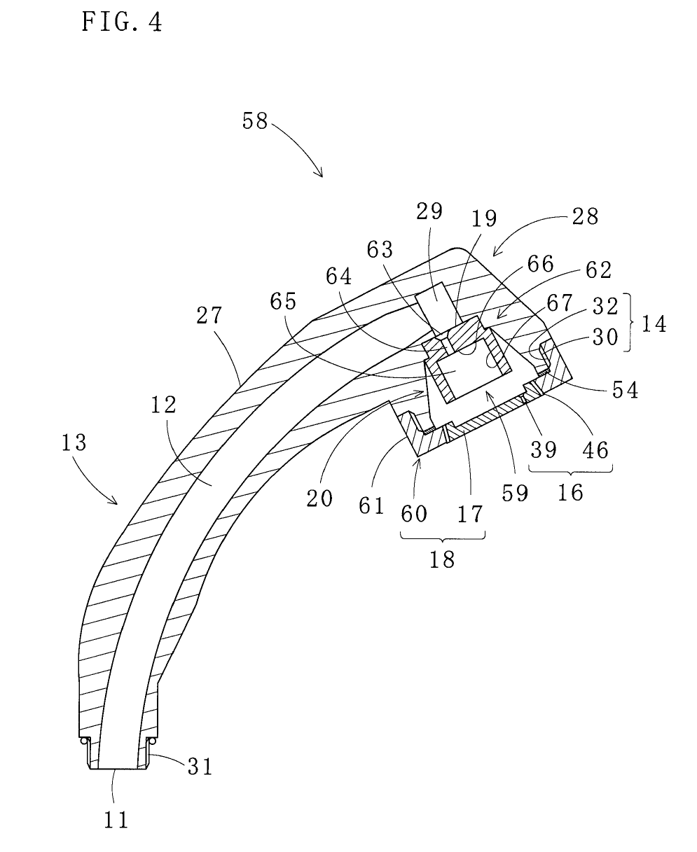

As illustrated in FIG. 4, a feature of a shower head 58 according to a second embodiment of the present invention resides in the structure of a cavitating mechanism 59 different from the counterpart of the shower head 10 according to the first embodiment. Thus, the cavitating mechanism 59 alone will be described, and substantially the same components will be denoted with the same numerals, with a detailed description thereof omitted. Because the cavitating mechanism 59 has a structure different from that of the cavitating mechanism 57, a side wall portion 61 of a cap 60 is shorter than the side wall portion 33 of the cap 15 of the shower head 10.

In the space 20 formed in the discharge head portion 28, a water passage portion 62 is disposed with the proximal end thereof in close contact with the water outlet 19 and with the distal end thereof facing the rear face of the sprinkler plate 17. The water passage portion 62 has a tapered intake port 63 communicating with the inflected water passage 29 of the shower head body 13; a reduced water passage 64 communicating with the exit of the intake port 63; and an enlarged water-passage 65 communicating with the exit of the reduced water passage 64. The tapered intake port 63 has a cross-sectional area smaller than (or equal to) that of the inflected water passage 29. The reduced water passage 64 has a smaller cross-sectional area than that of the intake port 63. The enlarged water-passage 65 has a cross-sectional area rapidly increased as compared with that of the reduced water passage 64 (e.g., ten times or more greater than that of the reduced water passage 64). In this embodiment, the reduced water passage 64 is formed eccentrically with respect to an axis of the water passage portion 62.

The enlarged water-passage 65 is defined by a bottom wall 66 extending perpendicular to the axis of the reduced water passage 64 and a side wall 67 extending upright from the bottom wall 66. The enlarged water-passage 65 is distally open to the space 20. The water passage portion 62 may be, at the bottom wall, in a tapered shape enlarging in the water flow direction (with an opening angle at the bottom wall of, e.g., 120° to 180°, more preferably 160° to 180°, formed with respect to the axis of the reduced water passage 64). The reduced water passage 64 and the enlarged water-passage 65, formed in the water passage portion 62, constitute the cavitating mechanism 59.

By causing water to travel through the inflected water passage 29, through the water outlet 19, and then through the intake port 63, such constitution enables the resistance of the water to be reduced so that the water is efficiently taken into the reduced water passage 64. The water taken in is accelerated and increased in pressure while flowing through the reduced water passage 64, before discharged into the enlarged water-passage 65. The water discharged into the enlarged water-passage 65 is rapidly decelerated and thereby its pressure is reduced to generate the cavitation phenomenon, with the result that water boils or almost boils, at a water temperature as it is, to form vapor bubbles.

The shower head 58 according to the second embodiment of the present invention has the same function as that of the shower head 10 according to the first embodiment, and a detailed description thereof will be omitted.

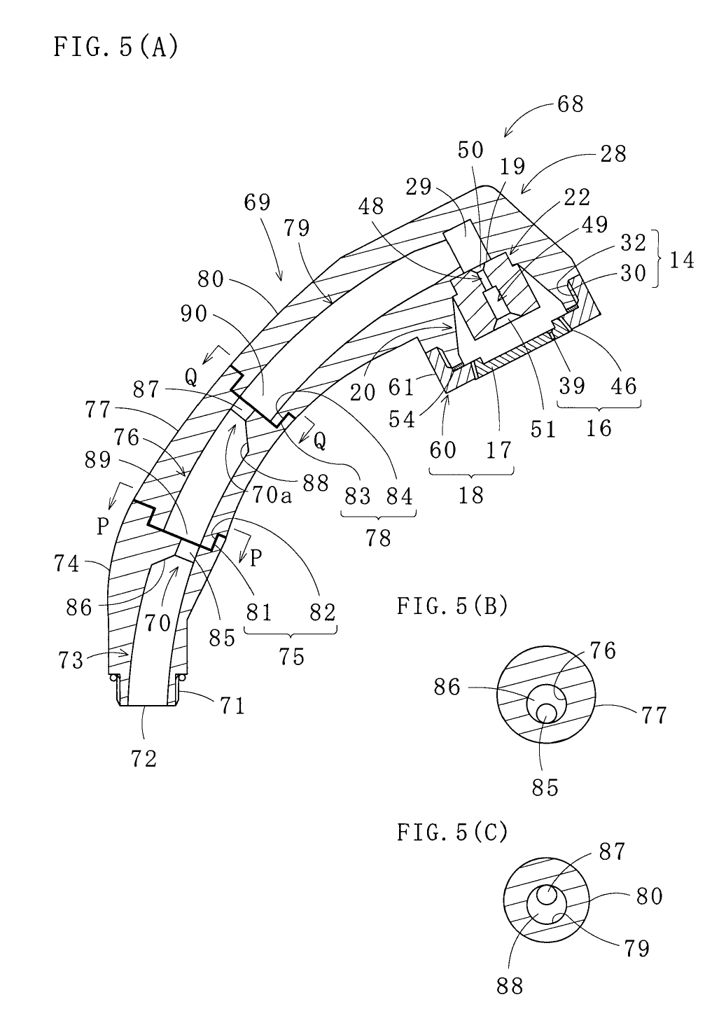

As illustrated in FIGS. 5(A)-(C), a shower head 68 according to a third embodiment of the present invention has the following features. In the space 20 of the discharge head portion 28 of the shower head 58 of the second embodiment, the water passage portion 22 of the first embodiment is disposed in place of the water passage portion 62. Also, in the water flow direction inside a handle portion of a shower head body 69, the cavitating mechanisms 70, 70a are arranged. Thus, the shower head body 69 alone, having the cavitating mechanisms 70, 70a, will be described, and substantially the same components will be denoted with the same numerals, with a detailed description thereof omitted.

The shower head body 69 includes a cylindrical first handle member 74; a cylindrical second handle member 77 having the proximal end fixed to the distal end of the first handle member 74 via a connecting mechanism 75; and a cylindrical third handle member 80 having the proximal end fixed to the distal end of the second handle member 77 via a connecting mechanism 78, and having the distal end joined to the discharge head portion 28. The first handle member 74 has a first water passage 73 inside and a water inlet 72 with a male screw portion 71 at the periphery thereof. The male screw portion 71 is to be fitted into a joint formed at the distal end of a shower hose (not illustrated). The second handle member 77 has a second water passage 76 inside. The third handle member 80 has a third water passage 79 inside that communicates with the inflected water passage 29. The first to third handle members 74, 77, 80 constitute a cylindrical handle portion with a water passage formed inside. The connecting mechanism 75 is constituted by a recess 81 formed at the distal end of the first handle member 74 and a projection 82 that is formed at the proximal end of the second handle member 77 and that is to be fitted in the recess 81. The connecting mechanism 78 is constituted by a recess 83 formed at the distal end of the second handle member 77 and a projection 84 formed at the proximal end of the third handle member 80. The projection 84 is to be fitted in the recess 83.

Provided at a distal portion of the first water passage 73 of the first handle member 74 is a first partition member 86, as illustrated in FIG. 5(B). The first partition member 86 has a first reduced water-passage 85 formed off-center therein that is smaller in cross-sectional area than the first water passage 73. Provided at a distal portion of the second water passage 76 of the second handle member 77 is a second partition member 88, as illustrated in FIG. 5(C). The second partition member 88 has a second reduced water-passage 87 formed eccentrically therein that is smaller in cross-sectional area than the second water passage 76. Due to these constitutions, downstream from the first reduced water-passage 85, i.e., at the proximal end of the second water passage 76, there is formed a first enlarged water-passage 89 having a rapidly increased cross-sectional area (e.g., having a cross-sectional area ten times or more greater than that of the first reduced water-passage 85), whereby the cavitating mechanism 70 is formed. Also, downstream from the second reduced water-passage 87, i.e., at the proximal end of the third water passage 79, there is formed a second enlarged water-passage 90 having a rapidly increased cross-sectional area (e.g., having a cross-sectional area ten times or more greater than that of the second reduced water-passage 87), whereby the cavitating mechanism 70a is formed.

The function of the shower head 68 according to the third embodiment of the present invention will now be described. When a faucet or a hot and cold water mixing faucet (not illustrated) is opened, water having a certain water pressure is supplied through a shower hose (not illustrated) to the water inlet 72 of the shower head 68. Then, the water supplied through the water inlet 72 into the first water passage 73, is accelerated and increased in pressure when flowing through the first reduced water-passage 85, and then, rapidly decelerated and quickly reduced in pressure when discharged into the first enlarged water-passage 89. In the first enlarged water-passage 89, as a result, cavitation (a cavitation phenomenon) occurs, and water boils or almost boils without a change in water temperature to form vapor bubbles. It is assumed that at this time, bacteria in the water are exposed to a reduced pressure zone, and killed. When the pressure of the water discharged in the first enlarged water-passage portion 89 is restored, the generated bubbles collapse with formation of shock waves, which propagate around. It is also assumed that the shock waves impinge upon bacteria, and that the impact forces produced at that time result in the physical breakup (killing) of the bacteria.

The water discharged into the first enlarged water-passage 89, i.e., into the passage formed at the proximal end of the second water passage 76, is again accelerated with its pressure increased when flowing through the second reduced water-passage 87, and then rapidly decelerated with its pressure quickly reduced when discharged into the second enlarged water-passage 90. In the second enlarged water-passage 90, as a result, cavitation (the cavitation phenomenon) occurs again, and water boils or almost boils without a rise in water temperature to form vapor bubbles. At this time, bacteria remaining in the water are exposed to a reduced pressure zone, and killed. Also, shock waves formed at the collapse of generated bubbles physically break up (kill) the bacteria. The water thus sterilized is discharged through the inflected water passage 29 and through the water passage portion 22 into the space 20, and then discharged from the inner sprinkler holes 39 and the outer sprinkler holes 46 of the sprinkler portion 18.

### Experimental Example

A test water was prepared by adding a solution of Escherichia coli to distilled water (the number of Escherichia coli per milliliter of the test water was adjusted to approximately 1000 to 10000). Then, the shower head 10 according to the first embodiment of the present invention was secured via a shower hose to a water supplier of the test water, and the test water was supplied for one minute at a flow rate of approximately 8 liters per minute. Next, after the supply of the test water was stopped at the base of the shower hose, with the shower head 10 fixed at a height of approximately 1.6 m from the base of the shower hose, the test water was kept at a room temperature (approximately 21° C.) for 24 hours. Then, the test water was removed from the inside of the shower head 10 and the number of viable bacteria was measured, with the result that no viable bacteria were detected. Also, with respect to the test water taken out of a tank of the water supplier, the number of viable bacteria therein was measured immediately after the stop of the supply of the test water and 24 hours thereafter, to find that the numbers of viable bacteria immediately after the stop of the supply of the test water and 24 hours thereafter were 5300 and 1800, respectively.

### Comparative Example

The same experiment was carried out using a conventional shower head having no cavitating mechanism. The test water was taken out of the shower hose, and the number of viable bacteria was measured and found to be 1300. Also with respect to the test water taken from the tank of the water supplier, the number of viable bacteria was measured immediately after the stop of the supply and 24 hours thereafter, to find that the numbers of viable bacteria immediately after the stop of the supply and 24 hours thereafter were 6200 and 5900, respectively.

Consequently, it was confirmed that Escherichia coli are viable in conventional shower heads. Further, given the fact that viable Escherichia coli bacteria were found in the test water within the water supplier tank 24 hours after the stop of the supply of the test water, it seems unlikely that the storage of the test water at room temperature was responsible for the extinction of Escherichia coli. For these reasons, it is assumed that no viable Escherichia coli bacteria were detected in the test water taken out of the shower head 10 because a cavitation phenomenon occurred in the test water inside the shower head 10 and killed Escherichia coli to leave sterilized water in the shower head 10.

As mentioned above, when the shower head 10 was used, it was confirmed that no viable Escherichia coli bacteria were detected in the shower water discharged out of the shower head 10 or in the residual water in the shower head 10. Further, it was also confirmed that the residual water in the shower hose showed a remarkable decrease in the number of viable Escherichia coli bacteria. Note that the shower heads 58, 68 according to the second and third embodiments, respectively, which are also provided with the cavitating mechanism(s), produce the same effect as that achieved by the shower head 10 of the first embodiment.

The present invention has been described in detail herein referring to the embodiments, although it is to be understood that the invention is not limited to these embodiments, and various changes and modifications in numerical values and design may be effected therein without changing the gist of the invention. For example, in the second embodiment, the reduced water passage is formed off-center with respect to the axis of the water passage portion. The reduced water-passage, however, may be formed in the center of the water passage portion.

Also, in the third embodiment, the first and second reduced water-passages are formed off-center with respect to the centers of the first and second partition members, respectively. However, only either one of the first and second reduced water-passages may be formed eccentrically, or the first and second reduced water-passages may be formed in the centers of the first and second partition members, respectively. Further, the cavitating mechanism is provided in two stages in the flow direction. However, it may be provided in one stage or in not less than three stages.

### INDUSTRIAL APPLICABILITY

There occurs within the shower head a cavitation phenomenon (cavitation) wherein a great number of fine vapor bubbles are formed in a reduced pressure zone inside the water flow. This prevents the growth of bacteria within the shower head body and a shower hose. Thus, before use of a shower, there is no need to drain water collected in the shower.

1. A shower head comprising a cavitating mechanism for partially generating a cavitation phenomenon due to a change in cross section of water flow therein.

2. The shower head according to claim 1, wherein the cavitating mechanism comprises: a reduced water-passage for accelerating introduced water and increasing the pressure of the water; and an enlarged water-passage for rapidly decelerating the water which has passed through the reduced water-passage and decreasing the pressure of the water.

3. A shower head including: a shower head body having a water inlet formed at a proximal end of the body, and a sprinkler portion disposed at a distal end of the body and having a plurality of sprinkler holes,
wherein the body comprises: a tubular handle portion having a water passage inside, the water passage having the water inlet at a proximal end thereof; and a discharge head portion integrally joined to a distal end of the handle portion, and
wherein a space enclosed by the discharge head portion and the sprinkler portion is provided with a cavitating mechanism for partially generating a cavitation phenomenon due to a change in cross section of water flow therein.

4. The shower head according to claim 3, wherein the cavitating mechanism is formed by a reduced water-passage and an enlarged water-passage, the reduced water-passage eccentrically formed in a partition plate, the partition plate provided at a distal end of the discharge head portion, the enlarged water-passage located downstream from the reduced water-passage and upstream from the sprinkler portion.

5. The shower head according to claim 3, wherein the cavitating mechanism is formed by a water passage portion, the water passage portion having a reduced water-passage located upstream and an enlarged water-passage located downstream.

6. A shower head including: a shower head body having a water inlet formed at a proximal end of the body, and a sprinkler portion disposed at a distal end of the body and having a plurality of sprinkler holes,
wherein the body comprises: a tubular handle portion having a water passage, the water passage having the water inlet at a proximal end thereof; and a discharge head portion integrally joined to a distal end of the handle portion, and
wherein the handle portion is provided with a cavitating mechanism for partially generating a cavitation phenomenon due to a change in cross section of water flow therein.

7. The shower head according to claim 6, comprising a plurality of the cavitating mechanisms.
